(19) United States
(12) Patent Application Publication
(10) Pub. No.: US 2011/0038139 A1
(43) Pub. Date: Feb. 17, 2011

(54) OPTICAL FILM WITH REDUCED DISTORTION, METHOD OF MANUFACTURING THE SAME, AND DISPLAY APPARATUS HAVING THE SAME

(76) Inventors: Seunghwan CHUNG, Asan-si (KR); Dong-Yeol Yeom, Asan-si (KR); Gicherl Kim, Asan-si (KR); Insun Hwang, Suwon-si (KR)

Correspondence Address: Innovation Counsel LLP, 21771 Stevens Creek Blvd, Ste. 200A, Cupertino, CA, 95014, US

(21) Appl. No.: 12/684,623

(22) Filed: Jan. 8, 2010

(30) Foreign Application Priority Data
Aug. 17, 2009 (KR) 10-2009-0075807

(51) Int. Cl. G09F 13/04; B32B 7/00; B32B 7/02; B32B 38/10; G02B 27/12; G02B 5/02

(52) U.S. Cl. 362/97.1; 428/98; 428/212; 428/215; 156/229; 359/625; 359/619; 359/599

(57) ABSTRACT

An optical film includes a first base film having a first effective elongation axis that is skewed relative to a first reference line. The optical film further has a second base film having a second effective elongation axis that is opposingly skewed relative to the first reference line. Deformations are offset from each other when the deformations occur in the first and second base films in the directions of the first and second elongation axes due to variation of external temperature and humidity, thereby preventing the first and second base films from being excessively deformed.

### CROSS-REFERENCE TO RELATED APPLICATION

This application relies for priority upon Korean Patent Application No. 10-2009-0075807 filed on Aug. 17, 2009, the contents of which are herein incorporated by reference in their entirety.

### BACKGROUND

1. Field of Disclosure

The present disclosure of invention relates to an optical film, to a method of manufacturing the same, and to a display apparatus having the same. More particularly, the present disclosure relates to an optical film which can be prevented from becoming deformed or distorted from an idealized, strainless planar form due to strains induced from variations of external temperature and/or humidity.

2. Description of Related Technology

A display apparatus displaying an image using a light source for backlighting may include a number of optical films performing various light ray processing functions. For example, a first optical film may include a so-called prism layer that functions to improve brightness of an image displayed at the front of the display apparatus. A second optical film may include a so-called diffusion sheet that functions to diffuse passing through light rays such that brightness of an image displayed on the display apparatus is uniform across the display area of the apparatus.

Such optical films may be mass produced by elongating one or more polymer resins such that the processed polymer resin has a thinner thickness than prior to processing. During or after the manufacturing process however, the optical film may become excessively deformed or distorted in its microstructure due to variations of external temperature and/or humidity which then cause uneven straining in the microstructure of the thinned-by-elongation polymer sheet. As a result, the mass production product yield of the thinned optical film may be degraded or manufacturing costs for the optical film may be increased due to need for tight controls on temperature and humidity.

### SUMMARY

Exemplary embodiments in accordance with the present disclosure can provide mass produced optical films in which an external appearance of distortion or deformation in the planar structure thereof can be prevented or reduced.

The present disclosure also provides a method of mass production manufacturing of the optical film.

The present disclosure also provides a display apparatus having the optical film.

According to an exemplary embodiment, an optical film is mass produced as a bonded together combination of first and second base films each having a respective elongation axis that results from an elongation processing applied to that base film. More specifically, the first base film is incorporated into the optical film combination so as to provide a light incidence surface that is to receive light rays from a backlighting unit or the like. The second base film is incorporated into the optical film combination so as to provide a light exit surface that will output light rays passing through the optical film. One or more of the layers of the combination optical film functions as an optical processing layer and it may be provided on at least one of the light incidence surface or the light exit surface on in between so as to adjust traveling path directions or other characteristics of light rays passing through the optical film.

More specifically, the first base film is manufactured so as to have a first effective elongation axis extending at a first angle relative to a first film-cut reference line, and the second base film has a second effective elongation axis extending at a different second angle relative to a second film-cut reference line, where the first and second film-cut reference lines are hypothetically provided as extending through corresponding and overlying central positions of each of the first and second base films when viewed from a top plan view perspective. The first and second effective elongation axes cross each other at predetermined angles when viewed in the top plan view. In one embodiment, the crossing angles are substantially symmetrical relative to the overlapping film-cut reference lines of the first and second base films. (In the here summarized embodiment, the first and second film-cut reference lines are coextensive with an initial elongation axis of a common sheet from which the first and second base films are obtained. The initial elongation axis serves as a reference axis for comparing the first and second effective elongation axes as will be more readily apparent when FIG. 9 is described in detail.)

According to one exemplary embodiment, a method of manufacturing the combination optical film is as follows. A first precursor film sheet is provided. A second precursor film sheet is mass produced from the first precursor film sheet such that the second precursor film sheet has a plurality of differently angled effective elongation axes. This may be achieved by applying various forces to the first precursor film sheet during its elongation, including elongation forces in a first initial elongation direction and elongation forces in second directions different from the first initial elongation direction. The differently directed effective elongation axes formed in the second precursor film sheet may be defined according to intensities and directions of the elongation forces applied during the mass production elongation of the first precursor film sheet. Thereafter, at least one first base film and at least one second base film are cut out from the second precursor film sheet so that the at least one first base film has a first effective elongation axis extending in a first direction and the at least one second base film has a second effective elongation axis extending in a second direction. Next, after adhering the first base film to the second base film so that their respective effective elongation axes cross one another according to a predefined base-to-base transversing angle, an optical processing layer is formed on at least one of the first and second base films.

The first and second elongation axes cross each other when viewed in a top plan view according to the predefined base-to-base transversing angle. In one embodiment, the predefined base-to-base transversing angle is substantially symmetrically bisected by a film-cut reference line (or an initial elongation axis line), where the latter is a straight line passing through a center of the first and second base films after they have been bonded directly or indirectly to each other to form the optical film as a composite whole.

According to another exemplary embodiment, a display apparatus is provided to include a light source, a display panel receiving a light from the light source to display an image, and an optical film interposed between the light source and the display panel to adjust a traveling path of the light from the light source to the display panel. The optical film of the display apparatus is provided in accordance with the manufacturing process disclosed here for providing a reduced distortion optical film. As described above, according to the present disclosure, the optical film can be prevented from being excessively deformed or distorted due to the variation of strains and stresses that may develop in the optical film due to changes of temperature and/or humidity. Accordingly, the product yield of the optical film can be improved and the optical film can be easily manufactured.

Moreover, the display apparatus which incorporates such a reduced-deformation optical film may be prevented from being perceived as having optical processing distortions, thereby improving the display quality of the display apparatus.

### BRIEF DESCRIPTION OF THE DRAWINGS

The above and other aspects of the present disclosure will become more readily apparent by reference to the following detailed description when considered in conjunction with the accompanying drawings wherein:

FIG. 1 is an exploded perspective view showing a combination optical film having first and second base films incorporated into the combination optical film according to an embodiment;

FIG. 2 is a sectional view taken along line I-I′ of FIG. 1;

FIG. 3A is a schematic view showing a polymer material before the polymer material is elongated by a predefined elongation process;

FIG. 3B is a schematic view showing a polymer material after it has been elongated in a predetermined direction;

FIG. 4 is a sectional view showing an optical film according to another embodiment;

FIG. 5 is a sectional view showing an optical film according to still another embodiment;

FIG. 6 is a sectional view showing an optical film according to still another embodiment;

FIG. 7 is a sectional view showing an optical film according to still another embodiment;

FIGS. 8 and 9 are sectional views showing a method of manufacturing a base films of FIGS. 2 and 4 to 7;

FIG. 10 is a view showing a method of testing the amount of deformation from ideal strainless planar for optical films formed according to various ones of the exemplary embodiments;

FIGS. 11A and 11B are graphs showing test results of FIG. 10; and

FIG. 12 is an exploded perspective view of a liquid crystal display apparatus including at least one of optical films of FIGS. 2 and 4 to 7.

### DETAILED DESCRIPTION

Hereinafter, exemplary embodiments in accordance with the present disclosure will be described in detail with reference to accompanying drawings. However, the present disclosure of invention is not limited to the following embodiments but includes various applications and modifications. The following embodiments are provided to clarify the technical spirit of the present teachings and to sufficiently transmit the technical spirit of the present teachings to one having ordinary knowledge and skill in the pertinent field. Therefore, the scope of the present teachings should not be limited to the following specific embodiments. In addition, the size of the layers and regions of the attached drawings along with the following embodiments may be simplified or exaggerated for precise explanation or emphasis and the same reference numeral may often represent the same or similar components.

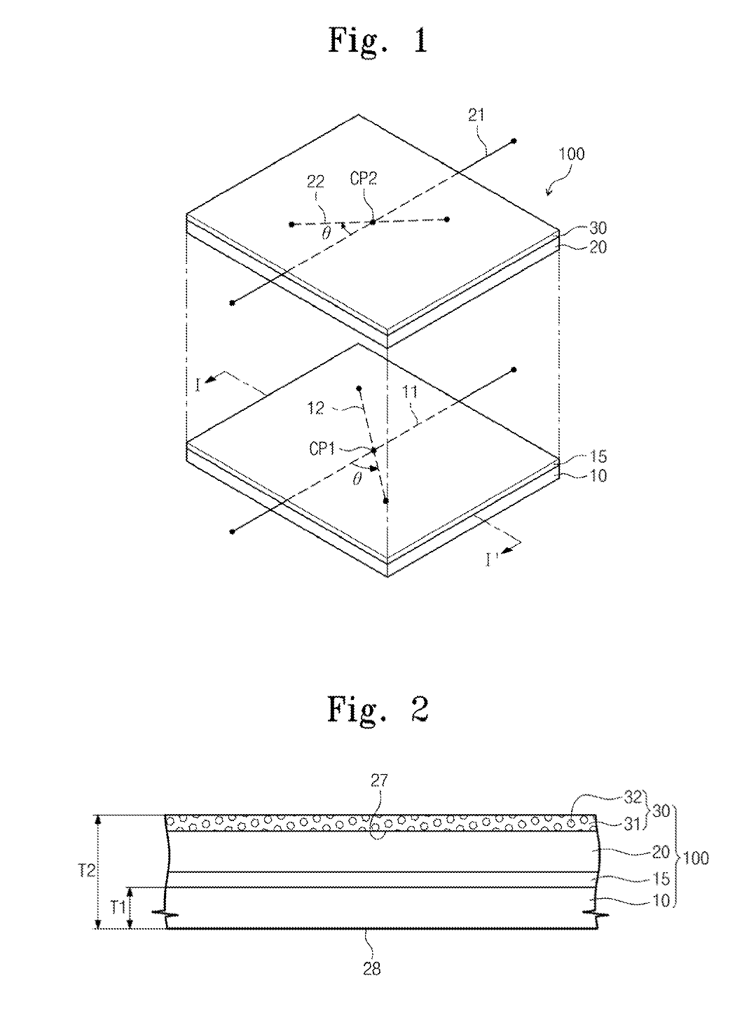

FIG. 1 is an exploded perspective view showing top and bottom portions of a combination optical film 100 according to a first embodiment and FIG. 2 is a sectional view taken along line I-I′ of a non-exploded version of the embodiment of FIG. 1.

Referring to FIGS. 1 and 2, the combination optical film 100 includes a first base film 10 having its bottom major surface provided to serve as a light incidence surface 28 of the combination optical film 100. The optical film 100 further includes a second base film 20 having its top major surface provided to serve as a light exit surface 27. An adhesion layer 15 is interposed between the first base film 10 and the second base film 20 to bond them together and thereby form the combination optical film 100 as an integral or composite whole. As one specific example of optical processing, a diffusion layer 30 is shown to be adhesively coated on top of the light exit surface 27 and to thus become an integral part of the combination optical film 100.

The first base film 10 and the second base film 20 may include a light passing polymer material such as polyethylene terephthalate (PET) or polycarbonate (PC) or another such polymer having relatively good light transmittance properties. According to one embodiment of the present disclosure, which embodiment is shown in FIG. 1, each of the first and second base films 10 and 20 is composed of the same chemical composition and that composition includes PET. The materials of the first and second base films, 10 and 20, may not be exactly identical in their microstructure orientations as will be detailed below.

The adhesion layer 15 adheres the first base film 10 to the second base film 20. The adhesion layer 15 may include a resin also having superior light transmittance. For example, the adhesion layer 15 may include at least one of an acrylic resin, a polyester resin, and a polycarbonate resin.

The adhesion layer 15 preferably has a refractive index approximately the same as that of the first base film 10. This is desirable so as to minimize internal reflections at the interface surface between the adhesion layer 15 and the first base film 10, where such internal reflections may be caused by a difference in refractive indexes between the adhesion layer 15 and the first base film 10. In particular, as the refractive index of the adhesion layer 15 shifts further and further away from the refractive index of the first base film 10, more undesired reflections of this type can occur.

For example, when the first base film 10 includes PET, since the PET has a refractive index of about 1.57, the adhesion layer 15 preferably includes acrylic resin having a refractive index of about 1.48 or polyester resin having a refractive index of about 1.48 as described above.

In addition, the adhesion layer 15 preferably has a refractive index approximately the same to that of the second base film 20 also.

Meanwhile, the first and second base films 10 and 20 may each have a first thickness T1 in a range of about 0.05 mm to about 0.5 mm. The optical film 100 may have a second thickness T2 in a range of about 0.1 mm to about 1.0 mm. If the first thickness T1 is less than about 0.05 mm, then when the correspondingly very thin first and second base films 10 and 20 are brought into adhesive contact with each other, the first and second base films 10 and 20 may be damaged due to their excessive thinesses. On the other hand, if the first thickness T1 exceeds about 0.5 mm, the thickness of the optical film 100 is increased such that a desired slimness of the optical film 10 may not be easily achieved. Accordingly, it is desirable to keep thicknesses T1 and T2 in respective predetermined ranges.

The diffusion layer or coating 30 includes a binder 31 and diffusion beads 32 dispersed inside the binder 31 to diffuse the light after it passes through the light exit surface 27. When the optical film 100 includes the diffusion coating/layer 30 as its optical processing layer, the combination optical film 100 may be seen as providing a light diffusion function as well as a mechanical support function for its included diffusion layer or coating 30. For example, in a liquid crystal display apparatus including a liquid crystal display panel (not shown) and a backlighting light source (not shown), the diffusion-providing optical film 100 is typically interposed between the liquid crystal display (LCD) panel and the light source to diffuse the light traveling from the light source to the liquid crystal display panel.

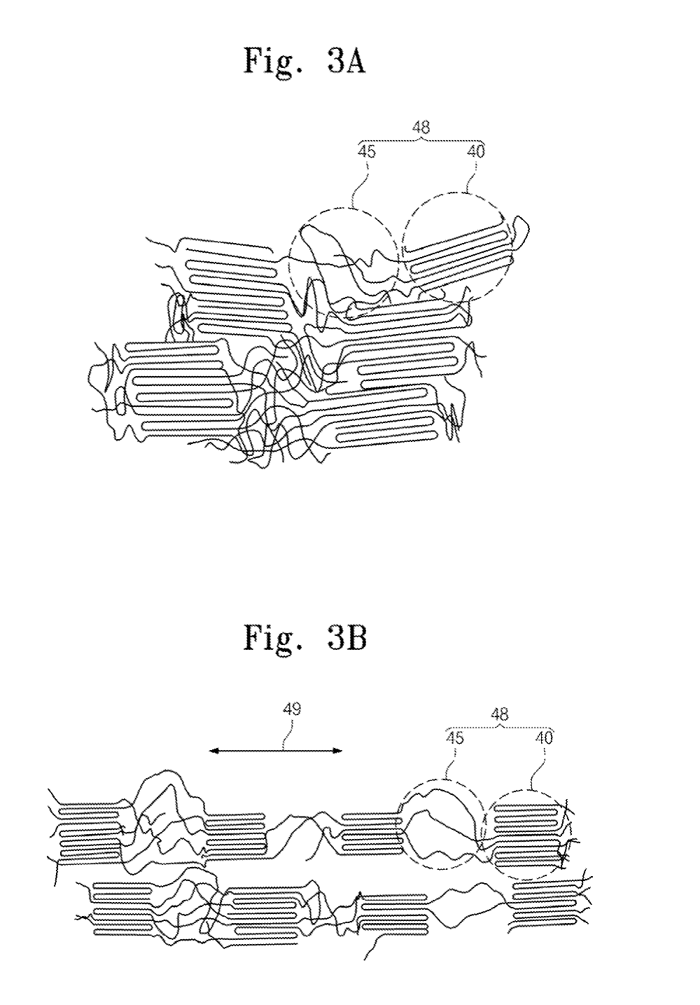

Meanwhile, when the first and second base films 10 and 20 are mass produced by elongating a polymer material such as PET or PC, each of the first and second base films 10 and 20 is caused to have a corresponding effective elongation axis. In other words, the polymer material constituting each of the first and second base films 10 and 20 is elongated in parallel to the corresponding effective manufacturing elongation axis such that microstructures within the polymer material are aligned in parallel to the effective elongation axis. Details thereof will be described below with reference to FIGS. 3A to 3B.

FIG. 3A is a schematic view showing a polymer material before the polymer material is elongated, and FIG. 3B is a schematic view showing the polymer material after it has been subjected to one or more elongation forces and thus elongated in a predetermined direction. The polymer material of FIGS. 3A and 3B may be PET or PC to be included in the first base film (10 of FIG. 1) and the second base film (20 of FIG. 1). When a polymer film is elongated plural times and according to various elongation forces exerted in different directions, its effective elongation axis is that which results from the plural elongations.

Referring to FIG. 3A, prior to any elongation, the microstructure of the polymer material 48 may include a plurality of crystalline parts 40 and a plurality of non-crystalline parts 45. Each of the crystalline parts 40 may have a crystalline structure less regular than that of a crystalline inorganic material (e.g., monocrystalline silicon), but may nonetheless include a plurality of polymers that are regularly folded so as to provide crystal like optical properties. In contrast, the non-crystalline parts 45 are randomly folded and they may be coupled in random directions with the adjacent crystalline parts 40. The orientations of the crystalline parts 40 can be relatively random prior to the initial or subsequent elongations.

Referring to FIG. 3B, after the polymer material 48 has been elongated at least once in accordance with an elongation-axis direction 49, the crystalline parts 40 are arranged to be more in parallel with each other and with the elongation-axis direction 49. Since the non-crystalline parts 45 are substantially spread along the elongation-axis direction 49, the alignment of the post-elongation polymer material 48 of FIG. 3B is more regular than that of the polymer material 48 of FIG. 3A. When the polymer material 48 is elongated in the elongation-axis direction 49, the polymer material 48 may have an alignment direction parallel to the elongation-axis direction 49.

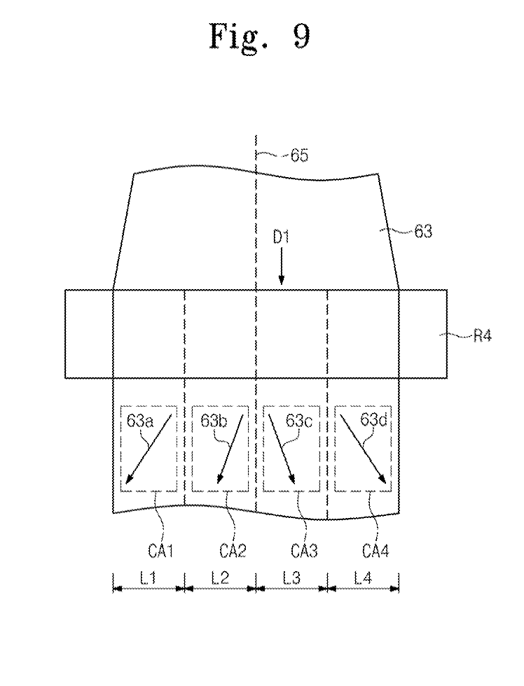

Referring to FIGS. 1 and 2 again, a first film-cut reference line 11 having the shape of a straight line is hypothetically defined on the first base film 10 according to a way in which the first base film 10 was cut out from a larger polymer sheet (as shall be described in more detail below). The first reference line 11 passes through a first central point CP1 of the first base film 10 when viewed in a top plan view. In addition, a second film-cut reference line 21 is hypothetically defined on the second base film 20 at a film-cut alignment identical to that of the first reference line 11 when viewed in a top plan view. The second reference line 21 passes through a second central point CP2 of the second base film 20 when viewed in the top plan view. (As mentioned above, the term, “film-cut reference line” is a way of orienting relative to an initial elongation axis (e.g., 65 of FIG. 9) of a sheet from which the first and second base films are cut according to their respective film-cut lines. This will become clearer when FIG. 9 is discussed in detail.)

The first base film 10 of the illustrated embodiment has a first effective elongation axis 12 (also, ELA₁), and the first elongation axis 12 forms a first acute angle θ1 with the first reference line 11 when viewed in the top plan view. The second base film 20 has the second effective elongation axis 22 (also, ELA₂). When viewed in the top plan view, the second elongation axis 22 forms a second acute angle θ2 with the second reference line 21 such that when both of ELA₁ and ELA₂ are viewed from the top plan view, the second elongation axis 22 crosses with the first elongation axis 12 relative to their overlapping first and second reference lines 11 and 12 and the combined transverse angle of formed by ELA₁ and ELA₂ is θ1+θ2. In one embodiment, θ1 is approximately equal to θ2 so that their respective effective elongation axes, ELA₁ and ELA₂ are substantially symmetrically disposed relative to the film-cut reference lines (or relative to a common initial elongation axis) as shall be explained in more detail below.

As described above with reference to FIGS. 3A and 3B, since the alignment direction of a one or more times elongated polymer material is parallel to the effective elongation-axis direction (49 of FIG. 3B), polymer materials of the first base film 10 are aligned in parallel to the first effective elongation axis 12, and polymer materials of the second base film 20 are aligned in parallel to the second effective elongation axis 22.

In general, a film manufactured by elongating polymer materials may have one or more deformations (strains) occurring therein; mostly in the effective elongation direction due to variations of external temperature and/or external humidity. As a result, optical characteristics such as the surface appearance of the film may be deformed or distorted somewhat in the elongation direction due to the temperature and/or humidity induced strains. However, according to one aspect of the present disclosure, if the first effective elongation axis 12 crosses the second effective elongation axis 22 when viewed in a plan view, the direction of a first deformation occurring inside the first base film 10 crosses the direction of a second deformation occurring inside the second base film 20 such that optical variations due to the first deformation appear to be offset by the optical variations due to the second deformation. Accordingly, the combination of the first and second base films 10 and 20, when bonded into an integral whole as illustrated can be prevented from exhibiting large optical variations due to their being individually stressed or strained by changes in temperature and/or humidity.

Meanwhile, herein, a sign of the first acute angle θ1 or the second acute angle θ2 is defined as plus (+) when the first acute angle θ1 or the second acute angle θ2 is measured from the first reference line 11 or the second reference line 21 in a counterclockwise direction when viewed from on top. In addition, the sign of the first acute angle θ1 or the second acute angle θ2 is defined as minus (−) when the first acute angle θ1 or the second acute angle θ2 is measured from the first reference line 11 or the second reference line 21 in a clockwise direction when viewed from on top. For example, when an acute angle between the first reference line 11 and the first elongation axis 12 is 30°, since the acute angle of 30° is measured from the first reference line 11 to the first elongation axis 12 counterclockwise, the first acute angle θ1 is defined as +30°. In addition, when an acute angle between the second reference line 21 and the first elongation axis 22 is 30°, since the acute angle of 30° is measured from the second reference line 21 to the second elongation axis 22 clockwise, the second acute angle θ2 is defined as −30°.

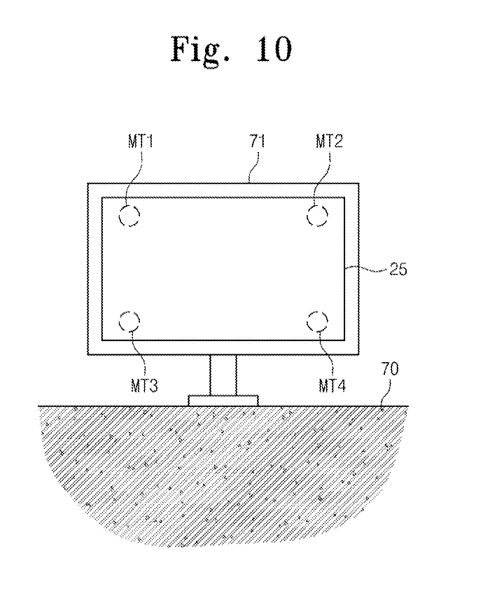

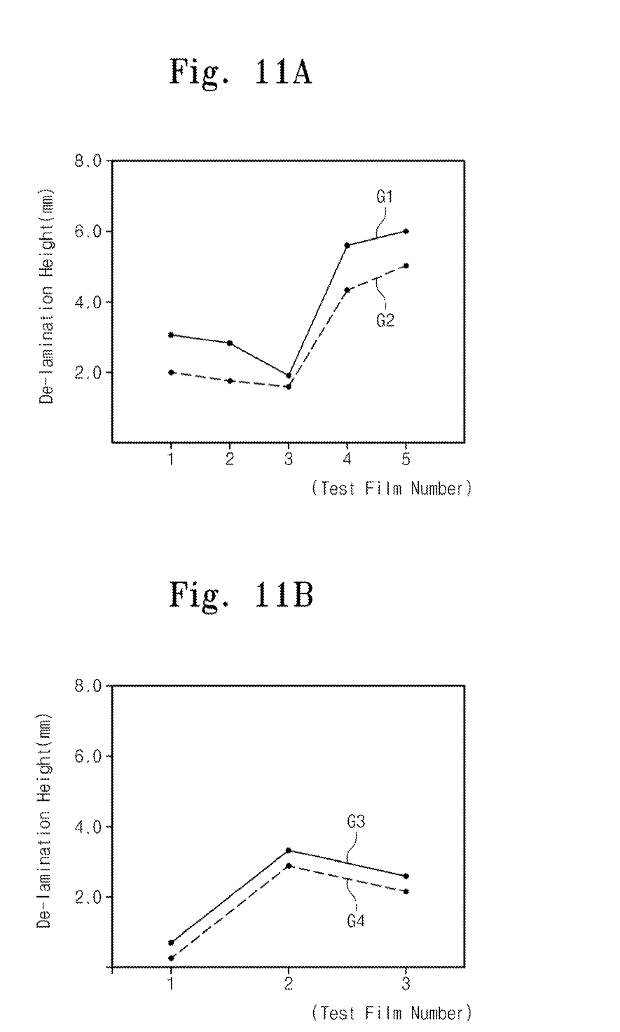

According to the embodiment shown in FIGS. 1 and 2, when the first acute angle θ1 and the second acute angle θ2 have signs different from each other, the offsetting of optical characteristic variations between the first deformation and the second deformation is greatly increased. In addition, when the difference between absolute values of the first acute angle θ1 and the second acute angle θ2 is very small on the assumption that the first acute angle θ1 and the second acute angle θ2 have signs different from each other, the offset between the first deformation and the second deformation greatly occurs. More detailed description thereof will be described below with reference to FIGS. 10, 11A, and 11B.

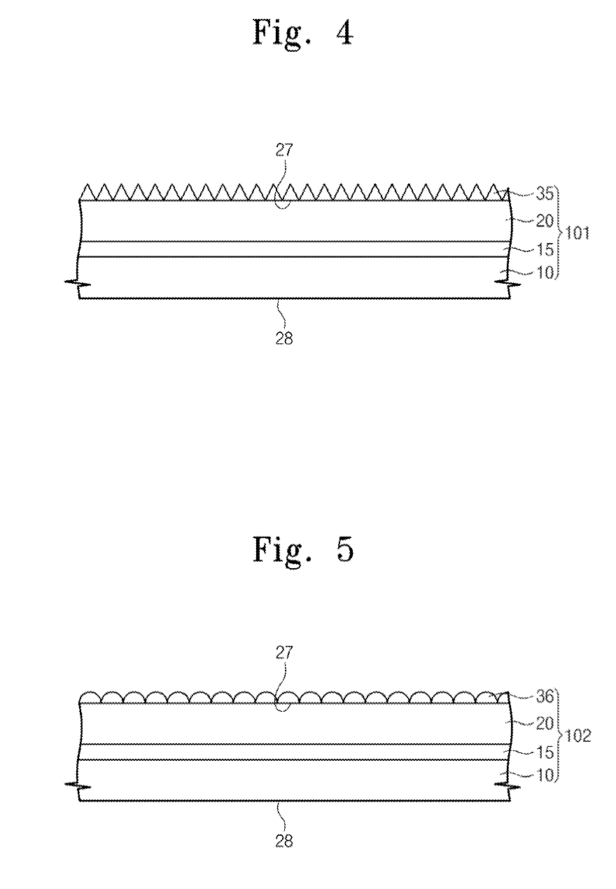

FIG. 4 is a sectional view showing an optical film 101 according to another embodiment. In the following description regarding FIG. 4, the same reference numerals will be assigned to elements identical to those of the embodiment that has been described with reference to FIGS. 1 and 2, and thus details thereof will be omitted.

Referring to FIG. 4, the optical film 101 includes the first base film 10, the adhesion layer 15, the second base film 20, and a prism pattern 35 provided on the light exit surface 27 of the second base film 20.

The prism pattern 35 adjusts the path of light output to an exterior through the light exit surface 27. In more detail, the prism pattern 35 substantially changes the path of light rays output through the light exit surface 27 in an oblique direction (non-normal) with respect to the second base film 20 into a direction substantially perpendicular to (normal to) the second base film 20. Accordingly, in an optical device using a light, the optical film 101 may serve as a prism film capable of improving front observed brightness. For example, in an LCD apparatus including a liquid crystal display panel (not shown) and a light source (not shown), the optical film 101 is interposed between the liquid crystal display panel and the light source to collect the light traveling from the light source to the liquid crystal display panel. Accordingly, the optical film 101 may be used to improve the front brightness of the LCD.

FIG. 5 is a sectional view showing an optical film 102 according to still another embodiment. The same reference numerals will be assigned to elements identical to those of the embodiment of the present invention that has been described with reference to FIGS. 1 and 2, and details thereof will be omitted.

Referring to FIG. 5, the optical film 102 includes the first base film 10, the adhesion layer 15, the second base film 20, and a micro-lens pattern 36 provided on the light exit surface 27 of the second base film 20.

The micro-lens pattern 36 diffuses a light output to an exterior through the light exit surface 27. Accordingly, in an optical device using a light, the optical film 102 may serve as a diffusion film capable of diffusing the light. For example, in an LCD apparatus including a liquid crystal display panel (not shown) and a light source (not shown), the optical film 101 is interposed between the liquid crystal display panel and the light source to diffuse the light traveling from the light source to the liquid crystal display panel. Accordingly, the LCD apparatus can have uniform brightness over the whole display region thereof.

FIG. 6 is a sectional view showing an optical film 103 according to still another embodiment. The same reference numerals will be assigned to elements identical to those of the embodiment that has been described with reference to FIGS. 1 and 2, and details thereof will be omitted.

Referring to FIG. 6, the optical film 103 includes the first base film 10, the adhesion layer 15, the second base film 20, the diffusion layer 30 provided on the light exit surface 27, and diffusion beads 17 dispersed inside the adhesion layer 15.

The diffusion beads 17 may include an inorganic material such as silica, or an organic material such as poly methyl methacrylate (PMMA). The diffusion beads 17 diffuse the light passing the first base film 10 through the light incidence surface 28. Accordingly, the optical film 103 can improve a light diffusion function by employing the diffusion beads 17 in addition to the diffusion layer 30.

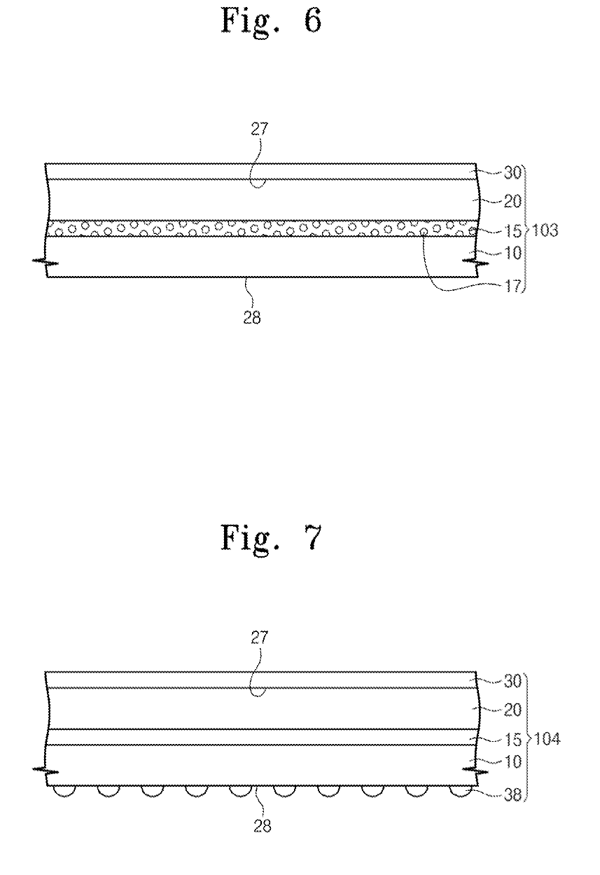

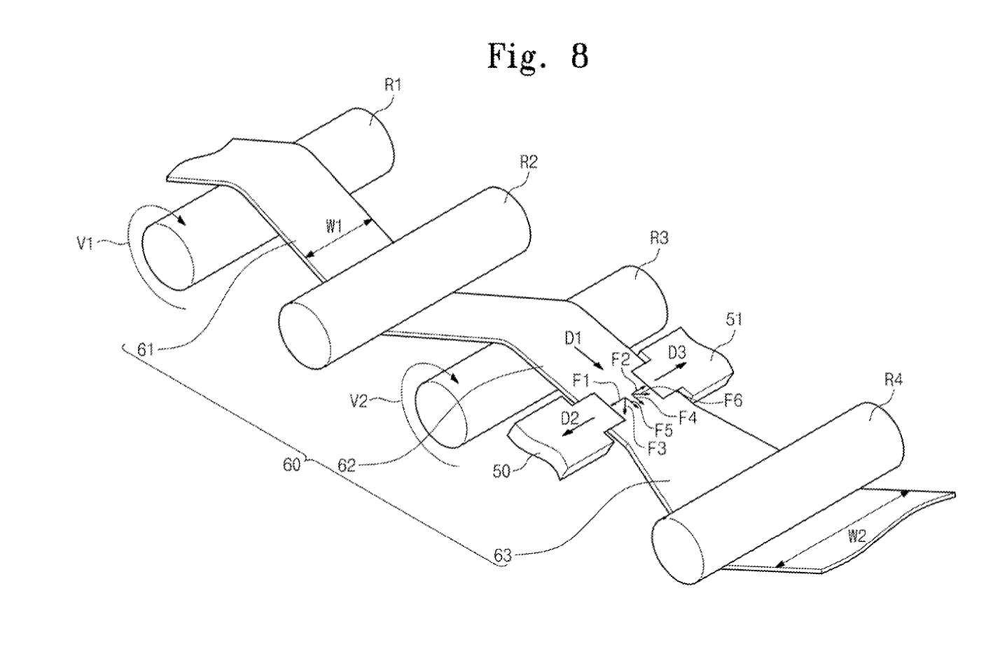

FIG. 7 is a sectional view showing an optical film 104 according to still another embodiment. The same reference numerals will be assigned to elements identical to those of the embodiment that has been described with reference to FIGS. 1 and 2, and details thereof will be omitted.

Referring to FIG. 7, the optical film 104 includes the first base film 10, the adhesion layer 15, the second base film 20, the diffusion layer 30 provided on the light exit surface 27, and convex spacer parts 38 provided on the light incidence surface 28.

When the optical film 104 is provided in adjacent to another element, the convex spacer parts 30 prevents the optical film 104 from making direct face-to-face contact with the element. For example, when the optical film 104 serves as a diffusion film to diffuse the light from the light source in the LCD apparatus including the liquid crystal display panel (not shown) and the light source (not shown), the convex spacer parts 38 prevent the optical film 104 from making contact with an element (e.g., a light guide plate (not shown)) provided in adjacent to the optical film 104.

Meanwhile, the optical film 104 may have surface roughness in the range of about 0.1 μm to about 50 μm due to presence of the convex parts 38. When the surface roughness is less than about 0.1 μm, the function of the convex parts 38 is degraded according to external conditions such that the contact area between the optical film 104 and another element may be increased. In addition, when the surface roughness is greater than about 50 μm, the light may be excessively scattered by the convex parts 38.

FIGS. 8 and 9 are sectional views showing a method of mass manufacturing the base films of FIGS. 2 and 4 to 7.

Referring to FIG. 8, first to fourth rolls R1 to R4 are provided, and first and second elongation devices 50 and 51 are disposed between the third and fourth rolls R3 and R4. A first preliminary base film 61 has a first width W1 and is sequentially wound about and between the first to the third rolls R1 to R3. The first preliminary base film 61 is forwarded in a first longitudinal direction D1 through the rotational motion of the first to the third rolls R1 to R3.

When the first preliminary base film 61 is forwarded in the first direction D1 by the first to the third rolls R1 to R3, the rotational speed of the first to the third rolls R1 to R3 is varied such that the first preliminary base film 61 can be initially elongated in the first direction D1 (the primary common elongation direction D1). For example, when the first and the third rolls R1 and R3 have the same diameter, the first roll R1 rotates at a first speed V1, and the third roll R3 rotates at a second speed V2 greater than the first speed V1, an initial elongating force acts on the preliminary base film 61 in the first direction D1. As a result, the first preliminary base film 61 is elongated in the first direction D1, so that a second interim base film 62 is formed during the mass production process.

Thereafter, while moving the second preliminary base film 62 by using the first to the fourth rolls R1 to R4 in the first direction D1, one lateral side of the second preliminary base film 62 is pulled by the first elongation device 50 in a second direction D2, and the other lateral side of the second preliminary base film 62 is pulled by the second elongation device 51 in a third direction D3. Accordingly, a first force F1 acts on the second preliminary base film 62 adjacent to the first elongation device 50 in the same direction as the second direction D2, and a second force F2 acts on the second preliminary base film 62 adjacent to the second elongation device 51 in the same direction as the third direction D3.

In addition, a forth deformation force F4 and a fifth force F5 act on the second preliminary base film 62 in the same direction as the first direction D1 according to the rotational motion of the first to the fourth rolls R1 to R4 together with the action of the first and second forces F1 and F2. Accordingly, a resultant third force F3, which is resultant force of the first force F1 and the fifth force F5, acts on the second preliminary base film 62 adjacent to the first elongation device 50, and a resultant sixth force F6, which is a resultant force of the second force F2 and the fourth F4, acts on the second preliminary base film 62 adjacent to the second elongation device 51.

As described above, when the second preliminary base film 62 is elongated by using the first and the second elongation devices 50 and 51, the second preliminary base film 62 is elongated in directions of the third force F3 and the sixth force F6, so that an interim third preliminary base film 63 is manufactured. Since the third preliminary base film 63 is elongated in the directions of the third force F3 and the sixth force F6, a second width W2 of the third preliminary base film 63 is greater than the first width W1.

Referring to FIG. 9, the third preliminary base film 63 wound around the fourth roll R4 has different effective elongation directions according to regions therein. This is because the first force F1 or the second force F2 acting on the third preliminary base film 63 is gradually increased toward the lateral sides of the third preliminary base film 63.

For example, if the third preliminary base film 63 is partitioned into two sections by a central line 65 (common reference line) parallel to the initial common elongation direction D1 and passing through the center of the third preliminary base film 63 when viewed in a plan view, third to sixth elongation axes 63a to 63d in the two sections of the third preliminary base film 63 are substantially symmetric to each other with respect to the central line 65. In addition, when each section is partitioned into two sub-sections, in other words, the third preliminary base film 63 is divided into first to fourth regions L1, L2, L3, and L4, the third effective elongation axis 63a corresponding to the first region L1 is substantially symmetric to the sixth effective elongation axis 63d corresponding to the fourth region L4 with respect to the central line 65. The fourth effective elongation axis 63b corresponding to the second region L2 is substantially symmetric to the fifth effective elongation axis 63c corresponding to the third region L3 with respect to the central line 65.

As a first cut-out region CA1 and a fourth cut-out region CA4 are cut out from the third preliminary base film 63 or a second cut-out region CA2 and a third cut-out region CA3 are cut out from the third preliminary base film 63, to thereby produce corresponding base films (similar to the first and second base films 10 and 20 of FIG. 1, and where the longitudinal film-cut lines are parallel to the initial common elongation direction D1) having effective elongation axes symmetrically crossing each other when viewed in a view can be manufactured by mass production means.

For example, if the first cut-out region CA1 is cut out from the third preliminary base film 63, a base film having the second acute angle (θ2 of FIG. 1) with a minus sign can be manufactured. If the fourth cut-out region CA4 is cut out from the third preliminary base film 63, a base film having the first acute angle (θ1 of FIG. 1) which has a plus sign and an absolute value similar to that of the second acute angle can be manufactured.

FIG. 10 is a view showing a method of testing the de-lamination of optical films according to the embodiments of the present disclosure, and FIGS. 11A and 11B are graphs showing a test result of FIG. 10.

Referring to FIG. 10, a test film 25 is provided for 96 hours under a condition in which temperature of 60° C. and humidity of 75% are maintained. The test film 25 may have the structure of one of the optical films (100 of FIG. 2, 101 of FIG. 4, 102 of FIG. 5, 103 of FIGS. 6 and 104 of FIG. 7) except for the size of the first angle (θ1 of FIG. 1) and the second angle (θ2 of FIG. 1) being varied.

After the test film 25 has been provided under the above condition, the test film 25 is attached to an ultra-flat plate 71, which is fixed to be essentially perfectly perpendicular to a ground surface 70 (in line with gravity). In this case, only the uppermost portion of the test film 25 is attached to the plate 71. Thereafter, the de-lamination degree of the test film 25 from the plate 71 is measured at first to fourth measurement points MT1 to MT4. If the film has no strains in it due to temperature and/or humidity, it can lie almost perfectly flat with the ultra-flat plate 71. On the other hand, if the film has strains, it will delaminate from the ultra-flat plate 71 in one way or another so as to have measurable delamination heights.

FIG. 11A shows the test result for the de-lamination of the test film 25. In more detail, the test is performed with respect to first to fifth test films. Following table 1 represents features of the first to fifth test films.

Meanwhile, as described above, since the first to fifth test films have the structure of one of the optical films (100 of FIG. 2, 101 of FIG. 4, 102 of FIG. 5, 103 of FIGS. 6, and 104 of FIG. 7) except for the size of the first angle (θ1 of FIG. 1) and the second angle (θ2 of FIG. 1), each of the first to fifth test films includes the first base film (10 of FIG. 1) and the second base film (20 of FIG. 1).

TABLE 1

| | | | | | Average |
|---|---|---|---|---|---|
| | Thickness | | | Maximum | de- |
| | of | 1^{st} | 2^{nd} | de-lamination | lamination |
| Classification | test film | angle | angle | height | height |
| 1^{st} test film | 0.24 mm | +33° | +30° | 3.0 mm | 2.0 mm |
| 2^{nd} test film | 0.24 mm | +33° | −30° | 2.6 mm | 1.8 mm |
| 3^{rd} test film | 0.23 mm | +33° | −30° | 1.9 mm | 1.5 mm |
| 4^{th} test film | 0.24 mm | +33° | +30° | 5.6 mm | 4.5 mm |
| 5^{th} test film | 0.24 mm | −30° | −25° | 5.9 mm | 5.0 mm |

A first curve G1 of FIG. 11A represents maximum de-lamination heights of the first to the fifth test films, and a second curve G2 of FIG. 11A represents average de-lamination heights of the first to the fifth test films. Those skilled in the art can recognize from FIG. 11A and Table 1 that the maximum de-lamination height and the average de-lamination height of the whole test films are reduced when the product of the first and the second angles has a minus value as compared with when the product of the first and the second angles has a plus value. In other words, when the product of the first and the second angles has a minus value, deformations occurring in the test films due to external conditions are offset to each other such that the observed de-lamination of the test film (deviation from the ultra flat draped down state) can be reduced. In addition, the maximum de-lamination height and the average de-lamination height of the whole test films can be reduced as the thickness of the first and the second base films is reduced.

Referring to FIG. 11B, the test result for the de-lamination of first to third test films is shown. A test condition is the same as that of the test method of FIG. 10. In addition, since the first to the third test films have the structure of one of the optical films (100 of FIG. 2, 101 of FIG. 4, 102 of FIG. 5, 103 of FIGS. 6, and 104 of FIG. 7) except for the size of the first angle (θ1 of FIG. 1) and the second angle (θ2 of FIG. 1), each of the first to the third test films includes the first base film (10 of FIG. 1) and the second base film (20 of FIG. 1). Following table 2 represents features of the first to third test films.

TABLE 2

| | | | | | Average |
|---|---|---|---|---|---|
| | Thickness | | | Maximum | de- |
| | of | 1^{st} | 2^{nd} | de-lamination | lamination |
| Classification | test film | angle | angle | height | height |
| 1^{st} test film | 0.29 mm | +28° | −29° | 3.0 mm | 2.0 mm |
| 2^{nd} test film | 0.24 mm | +28° | +27° | 3.4 mm | 2.8 mm |
| 3^{rd} test film | 0.24 mm | −29° | −31° | 3.1 mm | 2.4 mm |

Similarly to the test result of FIG. 11A and table 1, those skilled in the art can recognize from FIG. 11B and Table 2 that the maximum de-lamination height and the average de-lamination height of the whole test films are reduced when the product of the first and the second angles has a minus value as compared with when the product of the first and the second angles has a plus value. In other words, when the product of the first and the second angles has a minus value, deformations occurring in the test films due to external conditions are offset to each other such that the de-lamination of the test film can be reduced.

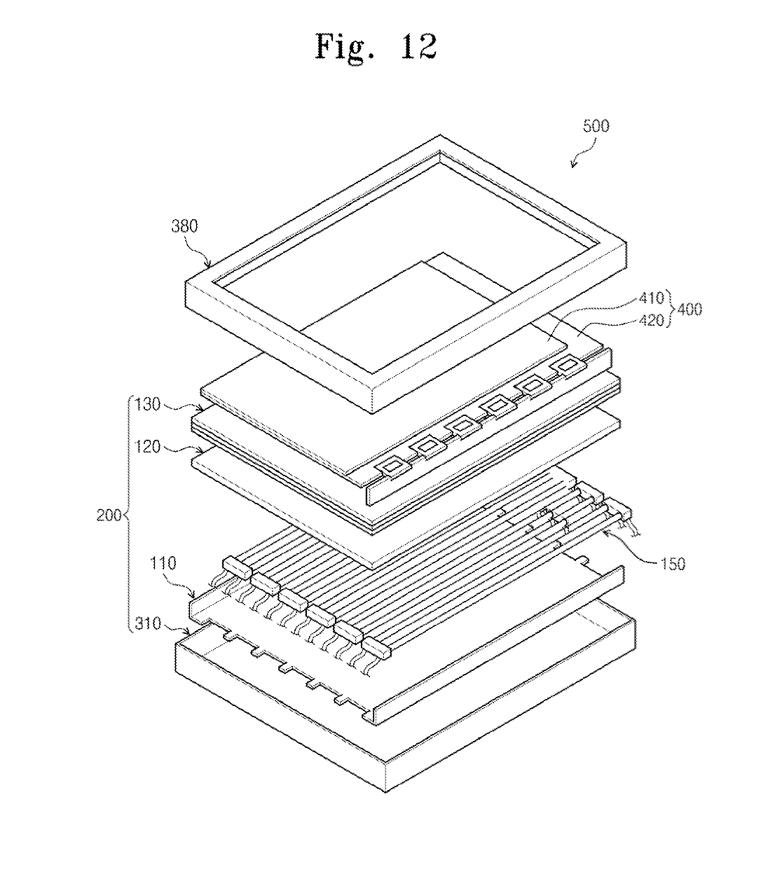

FIG. 12 is an exploded perspective view of an LCD apparatus 500 that includes at least one of the combination optical films 100 of FIGS. 2 and 4 to 7.

Referring to FIG. 12, the LCD apparatus 500 includes a backlight assembly 200 generating a light and a liquid crystal display panel 400 receiving the light from the backlight assembly 200 to display an image.

The backlight assembly 200 includes a plurality of lamps 150 (e.g., cold cathode fluorescents), a reflective plate 110, a bottom chassis 310 receiving the lamps 150 and the reflective plate 110, a diffusion plate 120, and a plurality of optical processing films 130.

In one embodiment, the lamps 150 have the form of line light sources and are arranged over the reflective plate 100 at a predetermined interval. The lamps 150 are connected with lamp electrode cables so that power generated from a high voltage inverter (not shown) is supplied to the lamps 150 through the lamp electrode cables. In an alternate embodiment, the backlighting unit may use edge lighting provided through a light guide plate (LGP, not shown) where the LGP guided light is then processed by various optical processing films like 130.

According to another embodiment similar to that shown in FIG. 12, the lamps 150 may be replaced by series of point light sources such as light emitting diodes (LEDs) or organic light emitting diodes (OLEDs). The lamps 150 may include various other kinds of light sources.

The reflective plate 110 includes a material reflecting a light, such as PET or aluminum (Al), and is provided on a bottom surface of the bottom chassis 310. The light reaching the reflective plate 110 without traveling toward the liquid crystal display panel 400 after the light has been generated from the lamps 150 can be supplied to the liquid crystal display panel 400 by the reflective plate 110.

According to the embodiment shown in FIG. 12, the lamps 150 may be disposed below the liquid crystal display panel 400. However, the position of the lamps 150 may be changed. In more detail, the lamps 150 may be disposed adjacent to at least one of inner sidewalls of the bottom chassis 310. If the lamps 150 are disposed adjacent to at least one of the inner sidewalls, the backlight assembly 200 may further include the aforementioned light guide plate (LGP, not shown). In that case, the lamps 150 are disposed side portions adjacent to thin edges of the light guide plate, so that the light generated from the lamps 150 enters the incident light side edges of the LGP and the light rays are thereafter redirected and guided to the liquid crystal display panel 400 by action of the light guide plate.

The diffusion plate 120 is provided above the lamps 150 to diffuse the light. Accordingly, the light generated from the lamps 150 can be uniformly supplied to the liquid crystal display panel 400 by the diffusion plate 120.

The optical films 130 are provided above the diffusion plate 120. The optical films 130 may include a prism sheet to collect the light that has passed through the diffusion plate 120 so that front brightness can be improved. When the optical films 130 include the prism sheet, the optical films 130 may have the same structure as that of the optical film 101 of FIG. 4.

The optical films 130 may include diffusion films to further diffuse the light passing through the diffusion plate 120. When the optical films 130 include the diffusion films, the optical films 130 may have the same structure as that of the optical film 100 of FIG. 2 or the optical film 102 of FIG. 5.

The liquid crystal display panel 400 includes a first substrate 420 on which thin film transistors (TFTs) are formed and a second substrate 410 facing the first substrate 420. The first substrate 420 includes a plurality of pixels (not shown). Each pixel includes a respective thin film transistor (not shown) and a respective pixel electrode (not shown) electrically connected with the thin film transistor.

The second substrate 410 includes color filters (not shown) provided in one-to-one correspondence to the pixels and a common electrode (not shown) forming an electric field with the pixel electrode. As a result, the direction of liquid crystal molecules interposed between the first substrate 420 and the second substrate 410 may be selectively changed by the electric field formed by the pixel electrode and the common electrode, thereby adjusting an amount of light passing through the first substrate 420 and the second substrate 410. Accordingly, the LCD 500 can display a desired image.

According to an alternate embodiment, the color filters may be formed on the first substrate 420.

According to an alternate embodiment, the second substrate 410 does not include the common electrode, but the first substrate 420 may include the common electrode. When the first substrate 420 includes the common electrode, the common electrode forms a lateral electric filed together with the pixel electrode to serve as an opposite electrode adjusting the director of the liquid crystal.

The bottom chassis 310 is provided with a bottom surface and sidewalls extending from the bottom surface, thereby forming a receiving space. The reflective plate 110 and the lamps 150 are received in the receiving space. The diffusion plate 120, the optical films 130, and the liquid crystal display panel 400 are sequentially provided above the lamps 150. A top chassis 380 is coupled with the bottom chassis 310 to cover the frame of the liquid crystal display panel 400.

Although the exemplary embodiments in accordance with the disclosure have been described, it is understood that the present disclosure should not be limited to these exemplary embodiments but various changes and modifications can be made by one ordinary skilled in the art after having read this disclosure where the changes are within the spirit and scope of the present teachings.

What is claimed is:

1. An optical film comprising:
a pre-elongated first base film composed of a polymer and having a respective first effective elongation axis extending in a first direction;
a pre-elongated second base film composed of the polymer and having a respective second effective elongation axis extending in a second direction that is different from the first direction;
wherein the first and second base films are bonded to one another directly or indirectly so they form integral parts of the optical film and wherein the bonding is such that the first effective elongation axis crosses at an angle with the second effective elongation axis according to the respective and different first and second directions.

2. The optical film of claim 1, wherein the pre-elongated first and second base films share an initial common elongation axis along which both were initially elongated and wherein the first and second directions are respectively disposed on opposite sides of the initial common elongation axis.

3. The optical film of claim 2, wherein
each of the first and second base films comprises a pre-elongated polyethylene terephthalate or a pre-elongated polycarbonate.

4. The optical film of claim 2, wherein a transverse angle formed by the crossing of the first effective elongation axis and the second effective elongation axis is substantially bisected by the initial common elongation axis.

5. The optical film of claim 1, further comprising an adhesion layer interposed between the first and second base films such that the first base film is bonded to the second base film by means of the adhesion layer.

6. The optical film of claim 7, wherein each of the first base film, the second base film, and the adhesion layer has a refractive index in a range of about 1.4 to about 1.6.

7. The optical film of claim 8, wherein the adhesion layer comprises at least one of acrylic resin, polyester resin, and polycarbonate resin.

8. The optical film of claim 5, wherein the adhesion layer contains diffusion beads that can diffuse light passing through the optical film.

9. The optical film of claim 1, wherein the optical film includes a prism pattern layer structured to direct light rays towards a normal axis of a major surface of the optical film.

10. The optical film of claim 1, wherein the optical film includes a micro-lens pattern structured to disperse light rays away from a normal axis of a major surface of the optical film.

11. The optical film of claim 1, wherein the optical film includes diffusion beads disposed to diffuse light passing through the optical film.

12. The optical film of claim 1, wherein each of the first base film and the second base film has a thickness in a range of about 0.05 mm to about 0.5 mm.

13. A method of manufacturing a composite optical film, the method comprising:
applying elongation forces to a first preliminary base film according to a first direction and then according to second directions different from the first direction so as to form a second preliminary base film having effective elongation axes defined according to intensities and directions of the cumulative effects of the applied forces;
cutting-out the second preliminary base film to form at least one first base film having a first effective elongation axis and forming at least one second base film having a second effective elongation axis by cutting-out the second preliminary base film;
bonding the first base film to the second base film; and
forming an optical processing layer on the bonded together first and second base films,
wherein directions of the effective elongation axes vary depending on regions of the second preliminary base film when the forces acting on regions of the first preliminary base film in the first direction and the second directions vary depending on the regions of the first preliminary base film, and
wherein the first and second effective elongation axes cross each other after the first and second base films are bonded together.

14. The method of claim 13, wherein the first direction is substantially parallel to a longitudinal direction of the first preliminary base film, and the second directions are substantially perpendicular to the first direction, so that the second directions match with directions through which opposite lateral sides of the first preliminary base film are away from each other.

15. The method of claim 14, wherein, when the second preliminary base film is partitioned by a straight central line passing through a center of the second preliminary base film and is substantially parallel to the first initial elongation direction, and positions in the second preliminary base film from where the first and second base films are cut out are substantially symmetric to each other with respect to the straight central line.

16. A display apparatus comprising:
a light source generating a light;
a display panel receiving the light from the light source to display an image; and
an optical film interposed between the light source and the display panel to adjust a traveling path of the light from the light source to the display panel,
wherein the optical film comprises:
a first base film comprising a light incidence surface to receive the light, a first elongation axis, and a first reference line;
a second base film comprising a light exit surface to output the light, a second elongation axis, and a second reference line provided at a position identical to a position of the first reference line when viewed in a plan view, the second base film being coupled with the first base film; and
an optical layer provided on at least one of the light incidence surface and the light exit surface to adjust the traveling path of the light,
wherein the first elongation axis crosses the second elongation axis on the first and second reference lines when viewed in a plan view.

17. The display apparatus of claim 16, wherein an angle measured counterclockwise from the first reference line or the second reference line is defined as a positive angle and an angle measured clockwise from the first reference line or the second reference line is defined as a negative angle when viewed in a plan view, a product of a first acute angle defined by the first reference line and the first elongation axis, and a second acute angle defined by the second reference line and the second elongation axis is a negative value.

18. The display apparatus of claim 17, wherein the first base film comprises a polymer aligned in a direction of the first effective elongation axis, and the second base film comprises a polymer aligned in a direction of the second effective elongation axis.

19. The display apparatus of claim 17, wherein the first effective elongation axis is substantially symmetric to the second effective elongation axis with respect to the first reference line or the second reference line when viewed from a top plan view over a major surface of the optical film.
